(19) United States
(12) Patent Application Publication
(10) Pub. No.: US 2022/0281569 A1
(43) Pub. Date: Sep. 8, 2022

(54) IR TRANSMITTER/RECEIVER BOAT TRAILER LOADING ASSIST

(71) Applicants: ZF FRIEDRICHSHAFEN AG, Friedrichshafen (DE); ZF MARINE PROPULSION SYSTEMS MIRAMAR, LLC, Miramar, FL (US)

(72) Inventors: Stefan TRAUB, Friedrichshafen (DE); Gabriela JAGER, Friedrichshafen (DE); Lars HOFFMANN, Fort Lauderdale, FL (US); Andrew ORVIETO, Plantation, FL (US)

(21) Appl. No.: 17/192,139

(22) Filed: Mar. 4, 2021

(51) Int. Cl. B63B 49/00; B63H 25/04; G06T 7/73

(52) U.S. Cl. CPC B63B 49/00; B63H 25/04; G06T 7/73; B63H 2025/028

(57) ABSTRACT

A system and method for guiding a boat onto a trailer, which comprises at least one marker mounted on the trailer; a camera located on the boat to assist the system with determining a longitudinal axis of the boat, and generating images of at least a front area of the boat and the at least one marker; an image processing unit for 1) receiving and processing the images to determine the at least one marker, 2) estimating the longitudinal axis of the trailer, 3) generating a desired boat trajectory for aligning the longitudinal axis of the boat with the longitudinal axis of the trailer; and 4) periodically generating guidance output commands to the user to assist the user with following the desired boat trajectory and facilitate loading of the boat on the trailer; and an image display for sequentially displaying the generated images of the camera to a user.

### FIELD OF THE INVENTION

This present invention generally relates to navigation, and more particularly to a system and a method which include at least one IR transmitter and at least one IR receiver that cooperate with one another to assist the user with aligning a vehicle or vessel, such as a boat, with an associated trailer, as the vehicle or vessel approaches the trailer, to facilitate safe and accurate loading of the vehicle on the trailer for subsequent transport and/or storage of the same on the trailer.

### BACKGROUND OF THE INVENTION

It is known that loading of a vehicle, such as boat, onto a trailer may be difficult, given the variability in ramp dimensions (i.e., the ramp length, the ramp width, the ramp inclination, etc.), the wind speed and the wind direction, the current wave conditions as well as the navigational skill of the operator of the vehicle.

In addition, boat ramps are frequently crowded with boaters facing substantial waiting times for access to the boat ramp in order to permit the boater to load or unload his/her boat on a trailer at the boat ramp. Such loading and unloading situations are often high pressure in nature since each operator, when his/her turn comes to launch or retrieve his/her vessel, tries to load/unload the vessel as quickly and efficiently as possible so as not to further hold up the boat loading/unloading queue at the boat ramp.

Further compounding the loading/unloading process is that boats are frequently loaded/unloaded from a trailer by a single operator, with no additional guidance or assistance from any other individual during the entire loading/unloading process.

Moreover, it is to be appreciated that damage may possibly occur, particularly during the boat loading process, to either the boat, the trailer, or both, or possibly damage may occur to a tow vehicle, e.g., a car or a truck, from being driven too far down the loading ramp so as to be unacceptably partially submerged in the water. It is to be appreciated that such damage can be very costly to repair and is generally to be avoided.

While the above noted problems are more often occur to individuals who are relatively new to boating and/or are generally inexperienced or have a lack of adequate training and/or skill, it is to be appreciated that even an experienced operator may also have difficulty in loading a boat on a trailer and/or an increased risk of causing damage to the boat and/or the trailer during a single person loading/unloading operation.

In view of the above drawbacks associated with the prior art loading/unloading techniques and operations, it would be beneficial for an operator to have a system which would consistently and reliably assist the operator with safely and efficiently guiding his/her boat, toward the associated trailer, and properly aligning and loading the boat on the trailer during the first attempt.

It is noted that a few prior inventions have proposed some solutions to the above noted problems. For example, a conventional marker-based navigation is described at http://wiki.ros.org/aruco_mapping.

The Applicant also recently filed a few patent applications relating to marker-based navigation. For example, DE 202466D relates to a method for controlling a vehicle which has at least one environment sensor; with the steps of recognizing the one or more markings, each of which is assigned a priority, in a sensor image; checking whether the marking with the highest priority is to be assigned to a left or a right part of the sensor image; steering the vehicle to the left when the marker is attributable to the left part; and steering the vehicle to the right when the marker is attributable to the right part. In additional, DE 204659D relates to a method for controlling a vehicle which has at least one environment sensor with the steps of recognizing one or more markings, each of which is assigned a priority and at least one location, in a sensor image; for determining the marker with the highest priority; and controlling the vehicle in the direction of a location determined by the location information assigned to the marking with the highest priority.

Also known is U.S. Publication No. US2016/0264220 relates to a system and method for assisting with the loading of a boat at a desired parking target, such as boat trailer or dock. In one example, a light source is provided on a boat trailer to illuminate the trailer. A forward facing camera and corresponding monitor are provided on a boat. As the boat approaches the boat trailer, the light source makes the boat trailer more visible, especially in low light conditions. The light source is also visible on the monitor, making it easier for a boat operator to guide the boat to the trailer.

U.S. Publication No. US2016/0368578 relates to a method and apparatus using a camera and image display for improving navigation of the watercraft. The system may be used by a helmsman to view regions outside his/her unaided sight range. Objects ahead of and behind the watercraft, both above and beneath the surface, may be detected and navigation decisions are made thereby. The same method and apparatus may be used to improve viewing while backing a trailer. In any event, the images may be recorded for later viewing.

U.S. Pat. No. 10,011,211 relates to a trajectory module which is configured to determine a trajectory of a boat located in water behind a trailer that is hitched to a vehicle based on an image behind the vehicle captured using a rear facing camera of the vehicle. An illuminating module is configured to turn a right brake light of the vehicle ON and OFF when the trajectory of the boat is left of a longitudinal axis of the trailer and to turn a left brake light of the vehicle ON and OFF when the trajectory of the boat is right of the longitudinal axis of the trailer.

### SUMMARY OF THE INVENTION

Wherefore, it is an object of the present invention to overcome the above mentioned shortcomings and drawbacks associated with the prior art loading and unloading techniques and processes.

The present disclosure relates to a navigation system and method which includes at least one IR transmitter and at least one IR receiver that interaction with one another to assist the user with aligning the longitudinal axis of the boat with the longitudinal axis of the trailer, as the boat approaches the trailer, and will provide guidance information to the user to assist the user with achieving and maintaining the longitudinal axis of the boat aligned with the longitudinal axis of the trailer for safely and efficiently loading the boat onto the trailer.

The navigation system may include a (main) display screen of a mobile device to display a current image of the boat loading process, obtained by an integrated camera or some other camera, which informs the user, via an overlay display, that is displayed on a display screen of the mobile device, over a current image showing the boat loading process, to provide a visual indication to the user (boat operator) relating to how closely the boat is following the desired boat loading trajectory as the boat is approaching the trailer.

During a boat loading operation, according to one embodiment, the navigation system and method generates guidance output commands to the user (boat operator), e.g., recommends to the boat operator to maintain the current course, or possibly does not provide any recommendation, when the navigation system determines that the boat is following along the desired boat loading trajectory. When the boat is straying from the desired boat loading trajectory, the navigation system may generate guidance output commands to the boat operator, e.g., to turn toward the port (left) side or to turn toward the starboard (right) side, until the boat is again back on course. Such commands thereby assist the boat operator with following along the desired boat loading trajectory and safely and efficiently loading the boat on the associated trailer.

According to one variant of the disclosure, the IR transmitter(s) is/are provided with adjustable blinders which assist the user with controlling and/or reducing the angle of propagation of the IR signals to be emitted/transmitted from the IR transmitter(s) toward the IR receiver(s), and each IR receiver(s) is also provided with adjustable blinders which assist the user with controlling the reception angle for receiving the transmitted IR signals, in the horizontal direction, from the IR transmitter(s).

According to another variant of the disclosure, the navigation system and method may optionally be provided with means for producing a warning signal or command when the boat is deviating from the desired boat trajectory to be followed and indicating that corrective action is required. The warning signal or command may be one of an optical signal, an acoustical signal, or a haptic signal and the navigation system and method may increase a frequency and/or a tempo of the acoustical signal or the haptic signal when more drastic corrective action is required by the user.

According to still another variant of the disclosure, the navigation system and method the camera may optionally continuously view and inputting image to the navigation system and method so that the user can monitor the boat loading process.

The disclosure further relates to a navigational system for guiding a boat onto a trailer, the navigational system comprising: at least one IR transmitter for transmitting IR signals; at least one IR receiver for receiving IR signals transmitted by the at least one IR transmitter; the at least one IR transmitter being supported on one of: adjacent a front of a trailer and along a longitudinal axis of the trailer for transmitting IR signals toward a rear of the trailer and along the longitudinal axis of the trailer; or on a boat and along a longitudinal axis of the boat for transmitting IR signals toward a front of the boat and along the longitudinal axis of the boat; the at least one IR receiver being supported on the other of: on the boat for receiving the transmitted IR signals from the IR transmitter; or adjacent the front of the trailer and along the longitudinal axis of the trailer for receiving the transmitted IR signals from the IR transmitter; and a processing unit communicating, with the at least one IR receiver, for determining when the IR signals, transmitted by the at least one IR transmitter, are received by the at least one IR receiver, and, when this occurs, the processing unit indicating to the user that the longitudinal axis of the boat is aligned with the longitudinal axis of the trailer.

The disclosure further relates to a method of guiding a boat onto a trailer, the method comprising: providing at least one IR transmitter for transmitting IR signals; providing at least one IR receiver for receiving IR signals transmitted by the at least one IR transmitter; locating the at least one IR transmitter on one of: adjacent a front of a trailer and along a longitudinal axis of the trailer for transmitting IR signals toward a rear of the trailer and along the longitudinal axis of the trailer; or on a boat and along a longitudinal axis of the boat for transmitting IR signals toward a front of the boat and along the longitudinal axis of the boat; locating the at least one IR receiver being on the other of: on the boat for receiving the transmitted IR signals from the IR transmitter; or adjacent the front of the trailer and along the longitudinal axis of the trailer for receiving the transmitted IR signals from the IR transmitter; and having a processing unit communicating, with the at least one IR receiver, for determining when the IR signals, transmitted by the at least one IR transmitter, are received by the at least one IR receiver, and, when this occurs, indicating to the user, via the processing unit, that the longitudinal axis of the boat is aligned with the longitudinal axis of the trailer.

### BRIEF DESCRIPTION OF THE DRAWINGS

The accompanying drawings, which are incorporated in and constitute a part of the specification, illustrate various embodiments of the disclosure and together with the general description of the disclosure given above and the detailed description of the drawings given below, serve to explain the principles of the disclosure. The disclosure of the invention will now be described, by way of example, with reference to the accompanying drawings in which:

FIG. 1 is a diagrammatic top plan view showing the IR navigation system and method according to a first embodiment of the disclosure;

FIG. 2 is a diagrammatic top plan view showing a variation of the IR navigation system and method according to the first embodiment of the disclosure;

FIG. 3 is a diagrammatic top plan view showing a second embodiment of the IR navigation system and method according to the disclosure;

FIG. 4 is a diagrammatic view showing the IR fields of view of the left and right IR receivers, the overlapped region, and IR transmission angle of the IR transmitter;

FIG. 5 is a diagrammatic top plan view showing a third embodiment of the IR navigation system and method according to the disclosure;

FIG. 6 is a diagrammatic representation of the navigation system and method with an image overlay, possibly highlighted in a color (e.g., yellow or red), to indicate that turning (e.g., port side) action is required by the user in order for the boat to follow the boat loading trajectory toward the trailer; and

FIG. 7 is a diagrammatic representation of the navigation system and method with an image overlay, possibly highlighted in another color (e.g., green), to indicate that the boat is correctly following the boat loading trajectory toward the trailer

It should be understood that the drawings are not necessarily to scale and that the disclosed embodiments are sometimes illustrated diagrammatical and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE PREFERRED EMBODIMENTS

The navigation system and the method 2, according to all of the embodiments of the disclosure, require at least one IR transmitter 12 (or possibly two IR transmitters 12), and at least one IR receiver 14 (or possibly to IR receivers 14). The at least one IR transmitter 12 is mounted on either the trailer 6 or the boat 4 while the at least one IR receiver 14 is mounted on the other of the trailer 6 or the boat 4. The navigational system and method 2 also includes an engine control unit or an ECU (computational unit) which is integrated into, connected to or communicates with the IR receiver 14, for processing the received IR signals from the at least one IR transmitter 12. Alternatively, instead of the ECU, it is to be appreciated that an internal processor of a mobile device 8 may be utilized and communicate wirelessly with the IR receiver 14. The processing unit (either the ECU and the internal processor of the mobile device 8) processes the received IR signals to assist the user with guiding and loading the boat 4 on to the associated trailer 6. Both the ECU and the internal processor of the mobile device 8 are hereinafter collectively referred to as the “processing unit”. It is to be appreciated that utilization of the mobile device 8 will provide the navigational system and method 2 with enhanced features, as discussed below in further detail.

The navigation system and method 2 also includes the vehicle, the vessel or the boat 4 (hereinafter generically referred to as a “boat”) which is to be unloaded/loaded and an associated trailer 6 upon which the boat 4 is to be unloaded/loaded. As is conventional in the art, the associated trailer 6 is towed by a conventional towing vehicle 10.

In the event that the mobile device 8 is employed, it may be releasably mounted, via a device bracket or the like, to the windscreen of the vessel, for example, or supported at some other conventional navigational and vantage point of the boat. Alternatively, the mobile device 8 may possibly be held by a hand(s) of the user, but such hand held use of the mobile device 8 and may possibly hinder the ability of the user to safely maneuver the boat, during the loading operation, while also holding the mobile device 8 in his/her hand(s).

During a loading operation of the navigational system and method 2, the navigational system and method 2 will assist the user with aligning the longitudinal axis of the boat LAB with the longitudinal axis of the trailer LAT. Thereafter, the navigational system and method 2 may continue to provide guidance information/commands to the user until the boat 4 is properly loaded on the trailer 6. As a result, the navigational system and method 2 are designed to guide and load the boat 4 on the trailer such that the longitudinal axis of the boat LAB is properly aligned with the longitudinal axis of the trailer LAT.

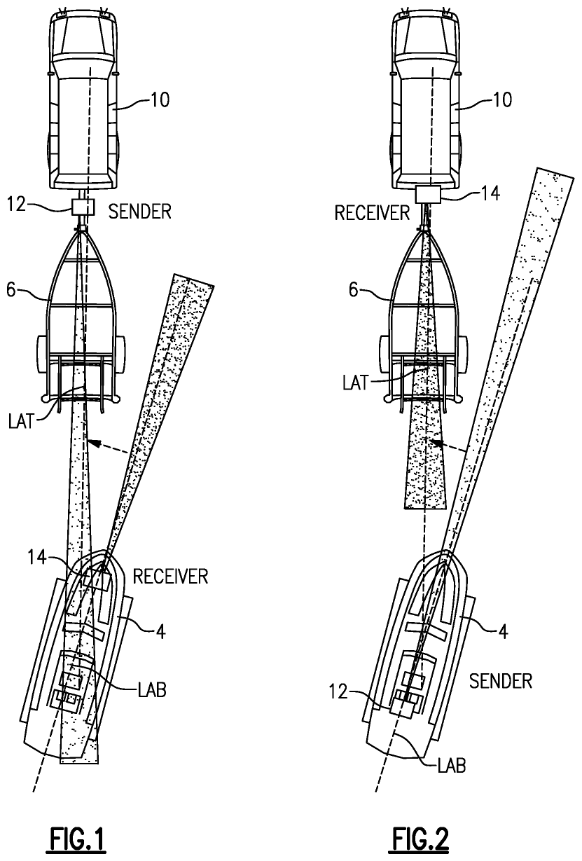

According to a first embodiment of a boat loading/unloading navigation system and method 2, as generally shown in FIG. 1, the IR transmitter 12 is mounted or supported by the associated trailer 6, e.g., typically by a suitable mounting bracket 18 (only diagrammatically shown). The mounting bracket 18 may be, for example, supported by or on the winch post of the trailer 6 or possibly supported by a portion of the trailer frame located between the winch post and the trailer hitch. It is to be appreciated that mounting bracket 18 is arranged so as to position and center the IR transmitter 12 with respect to and along a longitudinal axis of the trailer LAT. That is, the IR transmitter 12 is arranged to face toward the rear end of the associated trailer 6 and send or propagate IR signals along the longitudinal axis of the trailer LAT, in a direction toward the IR receiver 14, which is located on the boat 4. as discussed below in further detail, and thereby assist with aligning and loading of the boat on the associated trailer 6.

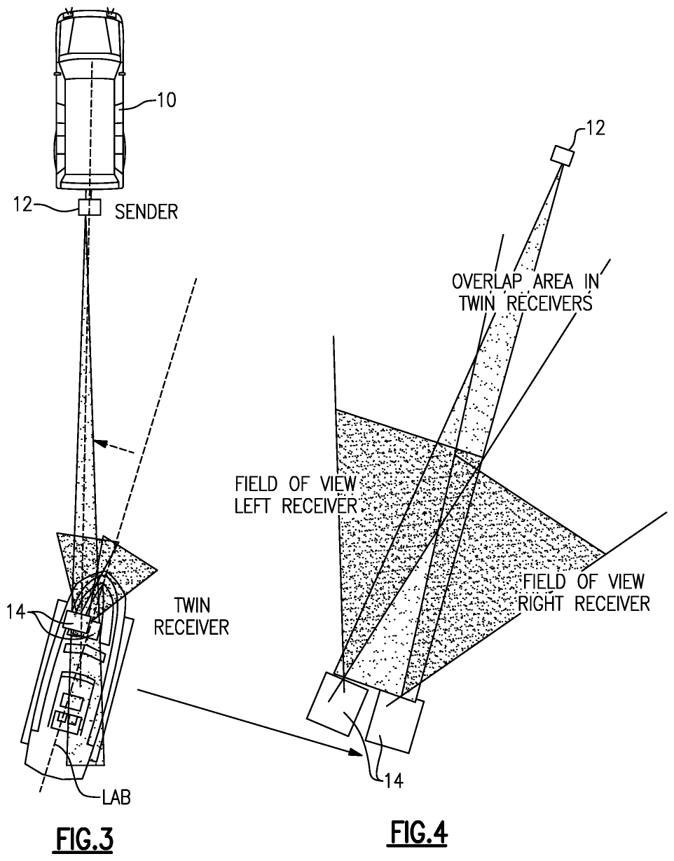

Preferably, the IR transmitter 12 is provided with adjustable blinders (not shown in detail) which assist the user with controlling and/or reducing the angle of propagation of the IR signals to be emitted/transmitted from the IR transmitter 12 toward the IR receiver 14 located on the boat 4. As generally shown in FIGS. 1 and 2, the blinders of the IR transmitter 12 are typically adjusted to “narrow” the transmission angle of the IR signals from the IR transmitter 12, in at least the horizontal direction, to about one to five degrees or so, preferably about one to two degrees, on either side of the longitudinal axis of the trailer LAT. Such narrowing of the horizontal transmitted IR signals from the IR transmitter 12 results in greater accuracy in aligning the longitudinal axis of the boat LAB with the longitudinal axis of the trailer LAT, as described below in further detail. It is to be appreciated that it is also feasible for the horizontal transmitted IR signals to be transmitted along a path greater than a few degrees, but, as noted above, this generally leads to less accurate alignment of the boat 4 with the trailer 6. It is to be appreciate that a variety of other conventional ways may be employed for controlling the IR transmission angle and the IR reception angle, without departing form the spirit and scope of the present disclosure. Either the mounting bracket 18 or the IR transmitter 12 may have conventional fine tuning adjustment controls to assist the user with adjusting propagation of the IR signals precisely along the longitudinal axis of the trailer LAT. It is to be appreciated that the propagation angle of the IR signals from the IR transmitter 12, in the vertical direction, toward the IR receiver 14 located on the boat 4, is not critical and, as such, it is not necessary for the blinders to alter propagation of the IR signals in the vertical direction.

The IR receiver 14 is generally mounted or supported by the boat 4, e.g., typically by a suitable mounting bracket 18, for example, which is typically supported in a vicinity of a bow area 20 of the boat 4. According to this embodiment, the mounting bracket 18 is arranged so as to align and center the IR receiver 14 with respect to and along a longitudinal axis of the boat LAB. That is, the IR receiver 14 is arranged to face toward the front bow area 20 of the boat 4 and receive the transmitted IR signals from the IR transmitter 12, and thereby assist with aligning and loading of the boat 4 on the associated trailer 6.

Preferably, the IR receiver 14 is also provided with adjustable blinders (not shown in detail) which assist the user with controlling the reception angle for receiving the transmitted IR signals, in the horizontal direction, from the IR transmitter 12. As generally shown in FIGS. 1 and 2, the blinders of the IR receiver 14 are also adjusted to “narrow” the IR signal reception angle of the IR receiver 14, in the horizontal direction, to typically between one half a degree to forty degrees or so, more preferably about one to five degrees or so, and most preferably about one to two degrees, on either side of the longitudinal axis of the boat LAB. Either the mounting bracket 18 or the IR receiver 14 may have conventional fine tuning adjustment controls to assist the user with adjusting reception of the IR signals precisely along the longitudinal axis of the boat LAB. Such narrowing of the horizontal IR signal reception angle of the IR receiver 14 results in greater accuracy in aligning the longitudinal axis of the boat LAB with the longitudinal axis of the trailer LAT, as described below in further detail. It is to be appreciated that the reception angle of the IR signals, from the IR transmitter 12, in the vertical direction is not critical and, as such, it is not necessary that the blinders also alter the IR signal reception angle in the vertical direction.

By narrowing the transmission angle of the IR signals, from the IR transmitter 12, and narrowing the reception angle of the IR signals, by the IR receiver 14, this achieves relative low tolerances for the navigation system and method 2 when the boat 4 is located at a position closely adjacent to the trailer 6, e.g., typically 20 yards or less away from the trailer 6. However, when the boat 4 is located further away from the trailer 6, e.g., at distance greater than 20 yards or so from the trailer 6 for example, then large tolerances occur. It is advantageous for the navigation system 2 to have relatively low tolerances when the boat 4 is located closely adjacent to the trailer 6, as this assists with very accurate final orientation and alignment of the boat 4 with respect to the trailer 6 during the loading operation.

As shown in FIG. 2, as alluded to above, the location of the IR transmitter 12 and the IR receiver 14 can be reversed without departing from the spirit and scope of the present disclosure. That is, the IR receiver 14 can be mounted on the trailer 6 while the IR transmitter 12 can be mounted on the boat 4.

In the event that the navigational system 2 is not preloaded with the associated software, then optionally the user can visit a conventional “App Store” and search for the trailer loading/unloading assist software, i.e., the App. Thereafter, the user will download the same on the user's mobile device 8, e.g., a smart phone, tablet, laptop, etc. Once this has occurred, the user will then launch the App on his/her mobile device 8. After launching the App, the App may prompt the user to enter the manufacturer, the model, and the year of manufacture of the boat 4 and also ask the user to select or verify the trailer 6, e.g., the manufacturer, the model, etc., upon which the boat 4 is to be loaded/unloaded. Next, the App may also typically confirm that the boat 4 can be properly and safely loaded/unloaded on and off the selected trailer 6. Assuming that the selected boat 4 can be properly loaded/unloaded from the selected trailer 6, then pre-loaded information, previously stored within the App, e.g., the length and the width of the boat, the length and the width of the trailer, etc., concerning both the selected boat 4 as well as the selected trailer 6, may be saved and stored in memory and the App files are correspondingly configured for use during operation. However, in the event that the App determines that the boat cannot be properly loaded on the selected trailer 6, then a suitable warning may be generated by the App and displayed on the (main) display screen 24 of the mobile device 8, e.g., “Warning: this boat is not designed for safe loading on this trailer.”

Optionally, during operation of the App by a user for the first time, or in the event that the user recently purchased another boat, etc., then it may be necessary for the user to select the type and the manufacturer of the trailer and also select whether the trailer is a single axle or a double axle trailer. After making such trailer selections, the user will then typically also select whether the boat supporting bed of the trailer 6 is equipped with either a plurality of rollers, has set of stationary bunks, etc., upon which the boat 4 will be supported during transportation and storage. Further, the user may also be required to select if the trailer 6 is equipped with one or more posts, and, if the trailer 6 has a plurality of posts, also select the post configuration of the trailer 6, e.g., a winch post at the front of the trailer 6 and a pair of side posts at the rear of the trailer 6, etc.

After all of the necessary boat and trailer selections are made and entered into the App and the pre-loaded information is correspondingly saved and stored in memory, then the files are correspondingly configured/updated in preparation for use of the App during a loading operation. Next, the App may check operation of the (main) display screen 24 of the mobile device 8, and possibly the internal sensors (e.g., the accelerometer, the GPS sensor, etc.) of the mobile device 8, to insure that they are all functioning properly.

Prior to use of the navigation system 2, the user typically will check to ensure that the IR transmitter 12 and the IR receiver 14 are both properly mounted. Then, the user confirms that the transmission/reception features of the paired IR transmitter 12 and the IR receiver 14 are all properly aligned with one another for sending and receiving the IR signals. In particular, the user will ensure that the transmission field of view TFV, of the IR transmitter 12, is precisely aligned with and coincident with the reception field of view RFV, of the IR receiver 14, in order for the IR signals to be properly transmitted and received between those two components. That is, the IR transmission component of the IR transmitter 12 and the IR reception component of the IR receiver 14 must both be centered with respect to and coincident with a vertical plane which extends through both the longitudinal axis of the trailer LAT and the longitudinal axis of the boat LAB. Once alignment of the IR transmitter 12 and the IR receiver 14, along both the longitudinal axis of the trailer LAT and the longitudinal axis of the boat LAB, is confirmed while the boat 4 is still loaded on the trailer 6, i.e., the “target state” is achieved, and now the navigational system and method 2 is ready for use.

According to this first embodiment, the navigational system and method 2 is generally unable to generate specific output commands to the user, e.g., “turn toward the starboard (right) side,” “turn toward the port (left) side,” “continue the current course,” etc. That is, the navigational system and method 2 generally only provides binary assistance/information to the user, namely, either the boat/trailer orientation is correctly aligned when the IR signals from the IR transmitter 12 are received by the IR receiver 14, or the boat and trailer axes are misaligned when the IR signals from the IR transmitter 12 are not, or are no longer, being received by the IR receiver 14. Such binary assistance/information still assists the user with aligning and maintaining the longitudinal axis of the boat LAB aligned with the longitudinal axis of the trailer LAT during loading of the boat 4 on the associated trailer 6.

With reference to FIG. 1, a loading operation, for loading the boat 4 on the associated trailer 6, will now be described in further detail. As generally shown in this figure, the IR transmitter 12 is transmitting an IR signal along the longitudinal axis of the trailer LAT toward the rear end of the trailer 6 while the boat 4 is located away from and floating in the water some distance away from the associated trailer 6, and the longitudinal axis of the boat LAB is not currently aligned with the longitudinal axis of the trailer LAT. As a result of such misalignment between the boat and trailer axes, the transmitted IR signal from the IR transmitter 12, due to the blinders of the IR receiver 14, is not viewable/receivable by the IR receiver 14. Such misalignment can be readily confirmed by the navigation system and method 2 since IR signals are not viewable/receivable by the IR receiver 14.

When misalignment of the longitudinal axis of the boat LAB with the longitudinal axis of the trailer LAT is significant, the user, operating the boat 4, will typically notice such misalignment of the boat 4 with respect to the trailer 6. As a result, the user will turn the boat 4, from the position shown in FIG. 1, toward the port (left) side until the longitudinal axis of the boat LAB is generally aligned with the longitudinal axis of the trailer LAT. As soon as this occurs, the IR receiver 14 commences receiving the IR signal transmitted from the IR transmitter 12 and such reception of the IR signal is immediately determined by the navigation system and method 2 and alignment. The navigation system and method 2 can indicate this to the user by generating an audio and/or a heptic guidance output command to the user or possibly an indication of the (main) display screen 24 of the mobile device 8. According to a currently preferred embodiment, the navigation system and method 2 includes the mobile device 8 with the (main) display screen 24.

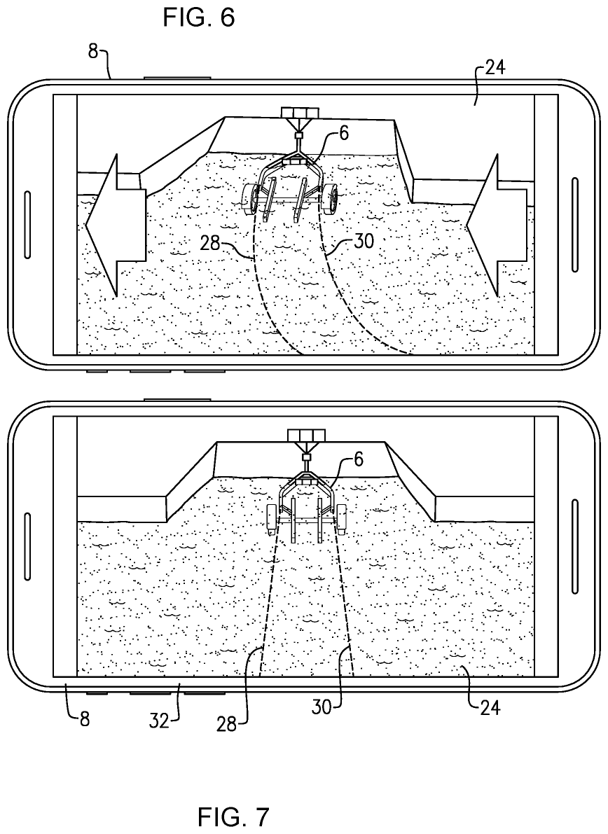

With reference now to FIG. 6, as diagrammatically shown, an image of the trailer 6, on which the boat 4 is to be loaded during loading procedure, is diagrammatically shown and displayed on the (main) display screen 24 of the mobile device 8. Since the IR receiver 14 is currently receiving the IR signal from the IR transmitter 12, the navigation system 2 determines that the longitudinal axis of the boat LAB is generally aligned with the longitudinal axis of the trailer LAT. As a result of this IR reception, the navigation system and method 2 is now able to generate and display, on the (main) display screen 24, i.e., a highlighted (green) trajectory overlay including left and right trajectory guides 28, 30, which depicts a desired straight ahead boat trajectory toward the detected IR transmitter 12 which is supported by the associated trailer 6. However, in the event that the IR receiver 14 is not currently receiving the IR signal from the IR transmitter 12, then the navigation system 2 determines that the longitudinal axis of the boat LAB is not generally aligned with the longitudinal axis of the trailer LAT. As a result of this, the navigation system and method 2 is able to generate and display, on the (main) display screen 24 (see FIG. 7), i.e., a highlighted in a red or yellow trajectory overlay for example, an output guidance command, including left and right trajectory guides 28, 30, which depicts that turning toward the port (left) side is required by the user in order for the boat 4 to follow the boat loading trajectory toward the trailer 6.

It is to be appreciated that during the loading operation, the boat is typically moving at a relatively slow and constant speed, e.g., 1-6 knots and more preferably about 1-3 knots per hour, toward the associated trailer 6. At the same time, the camera 12 is continuously generating and sending images to the processing unit 32 of the navigation system and method 2. For each received frame/image, during the entire duration of the loading or unloading process of the boat 4, the processing unit 32 will continue displaying the desired boat loading trajectory image overlay over the currently displayed image on the (main) display screen 24.

During operation of the navigation system and method 2, additional images of the current position of the boat 4, relative to the associated trailer 6, are generated by the camera 12 and sequentially displayed on the (main) display screen 24. The navigation system and method 2 will then overlay the boat loading trajectory overlay, over the most recently frame/image displayed on the (main) display screen 24, to assist with the user with visualizing and loading the boat 4 on the associated trailer 6. For each received frame/image, the processing unit 32 will indicate whether or not the longitudinal axis of the boat LAB is still generally aligned with the longitudinal axis of the trailer LAT, i.e., the current longitudinal axis of the boat LAB is generally parallel to, centered and located between the generated pair of overlay left and right trajectory guides 28, 30. In the event that this is the case, then the navigation system 2 determines that the boat 4 is currently following the desired boat loading trajectory. In such event, the navigation system 2 may possibly indicate the same to the user by an audio guidance output command, e.g, “continue current course,” indicate the same on the (main) display screen 24 or possibly not provide any audio and/or heptic guidance output command to the user.

However, in the event that the IR signal from the IR transmitter 12 is no longer being received by the IR receiver 14, the navigation system 2 thus determines that the boat 4 is deviating from the desired boat loading trajectory and the current longitudinal axis of the boat LAB is no longer generally parallel to, centered and located between the generated pair of overlay left and right trajectory guides 28, 30. When this occurs, the navigation system 2 may transmit an audio and/or a heptic guidance output command(s) to the user, e.g, “turn (left) port side,” as well as possibly providing a heptic guidance output command to the mobile device 8 of the user to indicate that corrective steering action is required, and it is to be appreciated that the user may possibly also eventually determine this on his/her own. This also may be graphically represented on the (main) display screen 24, as generally shown in FIG. 6, which graphically indicates to the user, via a pair of arrows for example, to turn toward port (left) side in order to again bring about alignment of the longitudinal axis of the boat LAB with the longitudinal axis of the trailer LAT.

As a result of such port (left) side corrective turning of the user, for example, the IR signal from the IR transmitter 12 is eventually again be received by the IR receiver 14. As soon as this occurs, then the navigation system and method 2 will again determine that the longitudinal axis of the boat LAB is again realigned with the longitudinal axis of the trailer LAT.

In a similar manner, in the event that the IR signal from the IR transmitter 12 is no longer being received by the IR receiver 14, the navigation system 2 again determines that the boat 4 is deviating from the desired boat loading trajectory and the current longitudinal axis of the boat LAB is no longer generally parallel to, centered and located between the generated pair of overlay left and right trajectory guides 28, 30. When this occurs, the navigation system 2 may transmit an audio and/or a heptic guidance output command(s) to the user, e.g, “turn starboard (right) side,” as well as possibly providing a heptic guidance output command to the mobile device 8 of the user to indicate that corrective steering action is required, and it is to be appreciated that the user may possibly also eventually determine this on his/her own in the event that the boat 4 has drifted significantly off course. This also may be represented on the (main) display screen 24 (not shown) to graphically indicate to the user, via by a pair of arrows for example, to turn toward starboard (right) side in order to again bring about alignment of the longitudinal axis of the boat LAB with the longitudinal axis of the trailer LAT.

The navigation system 2 will continue providing the user with appropriate guidance output commands until the boat 4 is safely and efficiently loaded on the associated trailer 6. As soon as this occurs, the boat loading operation discontinues and the navigation system 2 is typically switched (either automatically or manually) into a “standby” mode in the event that adjustment of the boat 4, relative to the trailer 6, is warranted or desired by the user. Once the user confirms that the longitudinal axis of the boat LAB is sufficiently aligned with the longitudinal axis of the trailer LAT, then the user can “turned off” the navigation system and method 2. Thereafter, the user may possibly attach the hook winch to the eye hook on the front of the boat 4 and crank the winch so as to pull the boat further on to the trailer 6. Then, the user will enter the tow vehicle 10 and drive the tow vehicle 10 and the loaded boat 4 away from the boat ramp and then stop at a safe location to continue securing and readying the boat 4 for transport on the trailer 6.

However, in the event that the navigation system and method 2 determine that the boat 4 can not be safely loaded on the associated trailer 6, given the current trajectory of the boat 4, the navigation system and method 2 may instruct/command the user to abort the current loading procedure, return back toward the initial boat loading location and thereafter commence another attempt at loading the boat 4 on the associated trailer 6.

In its simplest form, the navigation system and method 2 comprises at least one IR transmitter 12 and at least one IR receiver 14 (or possibly two IR receivers 14). The at least one IR transmitter 12 is mounted on either the trailer 6 or the boat 4 while the at least one IR receiver 14 is mounted on the other of the trailer 6 or the boat 4. The ECU is located adjacent to and communicates with the IR receiver 14. The ECU will generate guidance information/commands to the user to assist the user with properly loading the boat 4 on the trailer 6. The generate guidance information/commands to the user, from the ECU, could be a simple as turning on a light (e.g., a “green” light), or providing some other positive indication to the user, when the longitudinal axis of the boat LAB is aligned with the longitudinal axis of the trailer LAT, or turning on another light (e.g., a “red” light), or providing some other negative indication to the user, when the longitudinal axis of the boat LAB is not/no longer aligned with the longitudinal axis of the trailer LAT. According, the navigational system and method 2 assists the user with properly loading the boat 4 on the trailer such that the longitudinal axis of the boat LAB is properly aligned with the longitudinal axis of the trailer LAT.

Turning now to FIG. 3, a second embodiment of the present invention will now be described. As this embodiment is very similar to the previously discussed embodiment, only the differences between this new embodiment and the previous embodiment will be discussed in detail while identical elements will be given identical reference numerals.

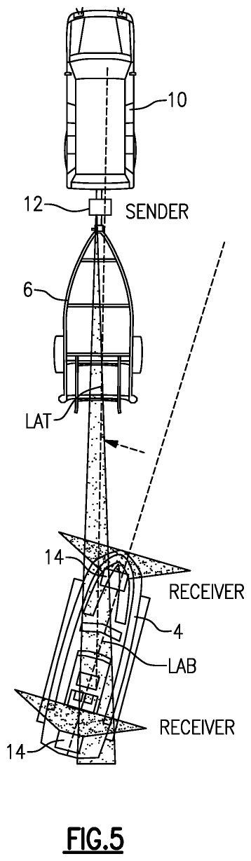

According to this embodiment, the navigation system and method 2 includes a signal IR transmitter 12 as well as left (first) and right (second) IR receivers 14. The IR transmitter 12 and the left (first) and the right (second) IR receivers 14 are, respectively, mounted on the trailer 6 and the boat 4. As shown, the transmission field of view TFV of the IR transmitter 12 is generally the same as described above with respect to the first embodiment, or possibly somewhat larger, while the reception field of view RFV of each one of the IR receivers 14 is increased to be about 45+35 degrees or so. As generally shown, each one of the IR receivers 14 is offset or located on opposite sides, e.g., 1-4 feet or so for example, of the longitudinal axis of the boat LAB. The left (first) and the right (second) IR receivers 14 are arranged so as to have an overlapped area or region (see FIG. 4) in which the transmitted IR signal from the IR transmitter 12 can be received by both the left (first) and the right (second) IR receivers 14. When the transmitted IR signal is received by both the left (first) and the right (second) IR receivers 14, the longitudinal axis of the boat LAB is generally aligned with the longitudinal axis of the trailer LAT. This is especially true the closer the boat 4 is located to the trailer 6.

Since both the left (first) and the right (second) IR receivers 14 have a somewhat larger reception field of view RFV, the left (first) and the right (second) IR receivers 14 can receive the transmitted IR signals from the IR transmitter 12 with even with somewhat great misalignment of the longitudinal axis of the boat LAB with the longitudinal axis of the trailer LAT. In view of this and in view of the fact that there are the left (first) and the right (second) IR receivers 14, the navigation system and method 2 is thus able, according to this second embodiment, to provide improved guidance information/commands to the user during the loading process.

For example, if the boat 4 is aligned as generally shown in FIG. 3, only the left (first) IR receiver 14 is receiving the transmitted IR signals from the IR transmitter 12 while the right (second) IR receiver 14, due to the adjusted position of its blinders, is unable to receive the transmitted IR signals from the IR transmitter 12. As a result of this, the navigation system and method 2 know that turning of the boat 4, toward the port (left) direction is required in order to bring about alignment of the longitudinal axis of the boat LAB with the longitudinal axis of the trailer LAT. The converse would also be also true, that is, if the boat 4 is aligned so that only the right (second) IR receiver 14 receives the transmitted IR signals from the IR transmitter 12 while the left (first) IR receiver 14, due to the adjusted position of its blinders, is unable to receive the transmitted IR signals from the IR transmitter 12, then the navigation system and method 2 knows that turning of the boat 4 toward the starboard (right) direction is required in order to align the longitudinal axis of the boat LAB with the longitudinal axis of the trailer LAT. As a result of such determination, the navigation system and method 2 can provide suitable guidance commands to the user, e.g, “turn starboard (right) side,” “turn port (left) side,” etc., during the loading procedure.

It is to be appreciated that according to the second embodiment, the ECU computational unit or the processing unit of the mobile device 8 also operate generally as discussed above and, as such, the associated description is not repeated herein.

Turning now to FIG. 5, a third embodiment of the present invention will now be described. As this embodiment is very similar to both of the previously discussed embodiments, only the differences between this new embodiment and the previous embodiments will be discussed in detail while identical elements will be given identical reference numerals.

According to this embodiment, the navigation system and method 2 includes a single IR transmitter 12 and bow and stern IR receivers 14. The IR transmitter 12 and the bow and stern IR receivers 14 are, respectively, mounted on the trailer 6 and the boat 4. As shown, the transmission field of view TFV of the IR transmitter 12 is generally the same as described above with respect to the first embodiment, possibly somewhat larger, while the reception field of view RFV of each one of the IR receivers 14 is increased to be about 130+45 degrees or so or may possibly be wide open and unrestrained IR receivers. As generally shown, each one of the bow and the stern IR receivers 14 is supported along the longitudinal axis of the boat LAB in-line with one another, but with one IR receiver 14 (typically the stern IR receiver 14) located vertically above or below the other IR receiver 14 so that, when the longitudinal axis of the boat LAB is generally aligned with the longitudinal axis of the trailer LAT, both the bow and the stern IR receivers 14 are receiving the transmitted IR signal from the IR transmitter 12 and be utilized to verify proper alignment of the longitudinal axis of the boat LAB with the longitudinal axis of the trailer LAT.

Since both the bow and the stern IR receivers 14 have a somewhat larger reception field of view RFV, the bow and the stern IR receivers 14 both may possibly receive the transmitted IR signals from the IR transmitter 12, even with some misalignment occurring between the longitudinal axis of the boat LAB and the longitudinal axis of the trailer LAT, provided that the reception element of the IR receiver 14 is currently positioned along the transmission path of the IR signals. In view of this and in view of the fact that there are bow and stern IR receivers 14, the processing unit 32 of the navigation system and method 2 can process both received IR signals and, based upon any variation of the reception angle received by the bow IR receiver and the stern IR receiver 14, relative to the longitudinal axis of the boat LAB, the processing unit 32 is able to determine a required turning direction of the boat 4 in order to bring about alignment.

For example, if the boat 4 is aligned as generally shown in FIG. 5, possibly only one of the bow IR receiver 14 and the stern IR receiver 14 will receive the transmitted IR signals from the IR transmitter 12, while the other of the bow IR receiver 14 and the stern IR receiver 14 will not. From the IR receiver 14 which receives the IR signal, the ECU can determine on which side of a longitudinal vertical plane, e.g., on the right side or the left side of the vertical plane, bisecting the IR receiver 14 that the IR signals are being received—the left side for instance as shown in FIG. 5. As a result of this, the processing unit 32 can generate guidance information/command, e.g., turning of the boat 4 toward the port (left) side is required in order to bring about align of the longitudinal axis of the boat LAB with the longitudinal axis of the trailer LAT.

The converse is also true, that is, if the boat is misaligned and headed toward the left of the trailer 6, again possibly only one of the bow IR receiver 14 and the stern IR receiver 14 may receive the transmitted IR signals from the IR transmitter 12, while the other of the bow IR receiver 14 and the stern IR receiver 14 will not. From the IR receiver 14 which receives the IR signal, the ECU can determine on which side of a longitudinal vertical plane, e.g., on the right side or the left side of the vertical plane, bisecting the IR receiver 14 that the IR signals are being received—the right side for instance. As a result of this, the processing unit 32 can generate guidance information/command, e.g., turning of the boat 4 toward the starboard (right) side is required in order to bring about align of the longitudinal axis of the boat LAB with the longitudinal axis of the trailer LAT.

When both the bow IR receiver 14 and the stern IR receiver 14 receive the transmitted IR signals from the IR transmitter 12, the longitudinal axis of the boat LAB is determined to be aligned with the longitudinal axis of the trailer LAT. In the event that such alignment of the longitudinal axis of the boat LAB with the longitudinal axis of the trailer LAT is subsequently lost so that the axes become misaligned with one another, then the navigation system and method 2 can provide turning assistance by implementing a “tracing” procedure. That is, by tracing the received signals over time in combination with any recent turning events of the boat 4 by the user, “I turned toward the port (left) side and lost the IR signals from the IR transmitter 12, I must have turned in the wrong direction or for too long a time and so now I will turn toward the starboard (right) side,” etc., in order to determine which direction to command the user to turn in order to again align the longitudinal axis of the boat LAB with the longitudinal axis of the trailer LAT.

It is to be appreciated that according to the third embodiment, the ECU computational unit or the processing unit of the mobile device 8 also operate generally as discussed above and, as such, the associated description is not repeated.

It is to be appreciated that the navigation system and method 2, according to the disclosure, can generate one or more warning sounds, warning lights and/or warning signals which may be periodically emitted, during operation of the navigation system and method 2, to assist the operator with safely and efficiently loading the boat onto the associated trailer 6. For example, the warning signal or vibration signal may be emitted by the navigation system or method 2 in the event that, given the current trajectory of the boat, it will not be possible for the longitudinal axis LAB of the boat to become properly aligned with the longitudinal axis LAT of the trailer. In response to such warning, the operator will then have to undertake drastic corrective action, e.g., rapidly slow down the travel speed of the boat 4, or possibly reverse the travel direction of the boat 4, in order to avert possible damage to the boat and/or trailer 6. In addition, a different warning signal or vibration signal may be emitted by the navigation system or method 2 in the event that speed of the boat is determined to be too fast for safely loading the boat on the associated trailer 6.

For acoustical guidance, the navigation system 2 can generate an acoustical signal which informs the user, due to frequency and/or tempo of the acoustical signal which is proportional to the distance the boat is from the trailer 6 and the relative alignment of the longitudinal axis of the boat LAB to the longitudinal axis LAT of the associated trailer 6 (similar to existing car parking sensors and their associated audible indicators). For example, the closer the boat 4 is located to the IR transmitter 12, the frequency and/or tempo of the acoustical signal thereby increases to indicated the same to the user. Alternatively or in addition, the navigation system 2 can provide haptic guidance, e.g., generate one or more a vibration signals, which increase in frequency and/or tempo the closer the boat 4 is to the IR transmitter 12.

It is to be appreciated that the navigation system and method 2 may be equipped with an infrared flickering pattern mode so as to associate the paired IR transmitter 12 with the pair IR receiver 14. This mode is particularly useful when one or more additional boats and/or trailers are located in the vicinity of the boat ramp and such boats/trailers are also using an IR assistance system or method.

Optionally, a connection may be established between either the IR transmitter 12 or the ECU or the processing unit of the mobile device 8 of the user so that the guiding assistance, provided by the navigation system and method 2 according to the disclosure, can be visualized by the user on the (main) display screen 24 of the mobile device 8 or audio control commands or vibrational feedback may be provided to the user during the loading operation.

While the navigation system and method 2 for a boat is described above, it is to be appreciated that the principles of this disclosure are directly applicable and can be utilized for other applications, e.g., to assist with loading a large construction equipment or a vehicle onto an associated trailer 6. In view of this, the term “vehicle,” as employed within this disclosure and the accompanying claims, is intended to mean and be construed to include any type of boat, vessel, piece of heavy equipment, vehicle, etc., which may be loaded on an associated trailer 6 and transported from one location to another location.

Inasmuch as the invention is subject to variations and improvements, it is intended that the foregoing shall be interpreted as merely illustrative of a presently preferred forms of the invention defined by the following claims.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

We claim:

1. A navigational system for guiding a boat onto a trailer, the navigational system comprising:
at least one IR transmitter for transmitting IR signals;
at least one IR receiver for receiving IR signals transmitted by the at least one IR transmitter;
the at least one IR transmitter being supported on one of:
adjacent a front of a trailer and along a longitudinal axis of the trailer for transmitting IR signals toward a rear of the trailer and along the longitudinal axis of the trailer; or
on a boat and along a longitudinal axis of the boat for transmitting IR signals toward a front of the boat and along the longitudinal axis of the boat;
the at least one IR receiver being supported on the other of:
on the boat for receiving the transmitted IR signals from the IR transmitter; or
adjacent the front of the trailer and along the longitudinal axis of the trailer for receiving the transmitted IR signals from the IR transmitter; and
a processing unit communicating, with the at least one IR receiver, for determining when the IR signals, transmitted by the at least one IR transmitter, are received by the at least one IR receiver, and, when this occurs, the processing unit indicating to the user that the longitudinal axis of the boat is aligned with the longitudinal axis of the trailer.

2. The navigation system according to claim 1, wherein the at least one IR transmitter comprises a single IR transmitter for transmitting the IR signals, and the single IR transmitter is located adjacent the front of the trailer and along the longitudinal axis of the trailer for transmitting the IR signals toward the rear of the trailer and along the longitudinal axis of the trailer; and
the at least one IR receiver comprises a single IR receiver for receiving the transmitted IR signals, and the single IR receiver is located on the boat and along the longitudinal axis of the boat for receiving the transmitted IR signals.

3. The navigation system according to claim 1, wherein the at least one IR receiver comprises a single IR receiver for receiving the transmitted IR signals, and the single IR receiver is located adjacent the front of the trailer and along the longitudinal axis of the trailer for receiving the transmitted IR signals; and
the at least one IR transmitter comprises a single IR transmitter for transmitting the IR signals, and the single IR transmitter is located on the boat and along the longitudinal axis of the boat for transmitting IR signals along the longitudinal axis of the boat and toward the trailer.

4. The navigation system according to claim 1, wherein the at least one IR transmitter comprises a single IR transmitter for transmitting the IR signals, and the single IR transmitter is located adjacent the front of the trailer and along the longitudinal axis of the trailer for transmitting the IR signals toward the rear of the trailer and along the longitudinal axis of the trailer; and
the at least one IR receiver comprises first and second IR receivers for receiving the transmitted IR signals, and the first IR transmitter is located on the boat, on a first side of the longitudinal axis of the boat, for receiving the transmitted IR signals while the second IR transmitter is located on the boat, on an opposite second side of the longitudinal axis of the boat, for receiving the transmitted IR signals.

5. The navigation system according to claim 1, wherein the at least one IR transmitter comprises a single IR transmitter for transmitting the IR signals, and the single IR transmitter is located adjacent the front of the trailer and along the longitudinal axis of the trailer for transmitting the IR signals toward the rear of the trailer and along the longitudinal axis of the trailer; and
the at least one IR receiver comprises bow and stern IR receivers for receiving the transmitted IR signals, and the bow IR receiver is located adjacent a bow portion of the boat and along the longitudinal axis of the boat for receiving the transmitted IR signals, while the stern IR receiver is located adjacent a stern portion of the boat and along the longitudinal axis of the boat for receiving the transmitted IR signals.

6. The navigation system according to claim 2, wherein the single IR transmitter is provided with adjustable blinders which assist with controlling an angle of propagation of the IR signals to be transmitted from the single IR transmitter, and the blinders adjust the transmission angle of the IR signals from the single IR transmitter, at least in a horizontal direction, and
the single IR receiver is also provided with adjustable blinders which assist with controlling a reception angle of the single IR receiver for receiving the transmitted IR signals, in the horizontal direction.

7. The navigation system according to claim 3, wherein the single IR transmitter is provided with adjustable blinders which assist with controlling an angle of propagation of the IR signals to be transmitted from the single IR transmitter, and the blinders adjust the transmission angle of the IR signals from the single IR transmitter, in at least a horizontal direction, and
the single IR receiver is also provided with adjustable blinders which assist with controlling a reception angle of the single IR receiver for receiving the transmitted IR signals, in at least the horizontal direction.

8. The navigation system according to claim 4, wherein the single IR transmitter is provided with adjustable blinders which assist the user with controlling an angle of propagation of the IR signals to be transmitted from the single IR transmitter, and the blinders adjust the transmission angle of the IR signals from the single IR transmitter, in at least a horizontal direction, and
each of the first and the second IR receivers are also provided with adjustable blinders which assist with controlling a reception angle for receiving the transmitted IR signals, in the horizontal direction.

9. The navigation system according to claim 5, wherein the single IR transmitter is provided with adjustable blinders which assist the user with controlling an angle of propagation of the IR signals to be transmitted from the single IR transmitter, and the blinders adjust the transmission angle of the IR signals from the single IR transmitter, in at least a horizontal direction, to about one to five degrees or so, and
each of the bow and the stern IR receivers are also provided with adjustable blinders which assist with controlling a reception angle for receiving the transmitted IR signals, in the horizontal direction.

10. The navigation system according to claim 1, wherein the system further comprises means for producing a warning signal or command when the boat is deviating from the desired boat trajectory to be followed and indicating that corrective action is required.

11. The navigation system according to claim 10, wherein the warning signal or command is one of an optical signal, an acoustical signal, or a haptic signal.

12. The navigation system according to claim 11, wherein at least one of a frequency and/or a tempo of the acoustical signal or the haptic signal increases when drastic corrective action is required by the user.

13. The navigation system according to claim 1, wherein when the system determines that the IR signal, from the single IR transmitter, is being received by the at least one IR receiver, the navigation system determines that the boat is following a desired boat loading trajectory and displays a boat loading trajectory overlay on a display screen of a mobile device indicating that the desired boat loading trajectory is being followed; and.
when the system determines that the IR signal, from the single IR transmitter, is no longer being received by the at least one IR receiver, the navigation system determines that the boat is not following a desired boat loading trajectory and displays a boat loading trajectory overlay which includes corrective action, on a display screen of a mobile device, to assist the user with following the desired boat loading trajectory.

14. The navigation system according to claim 13, wherein the boat loading trajectory overlay includes overlay left and right trajectory guides which have a first color signifying that the desired boat loading trajectory is being followed, and a second color signifying that corrective action is required in order to follow the desired boat loading trajectory

15. The navigation system according to claim 14, wherein the boat loading trajectory overlay includes overlay left and right trajectory guides which have a first color signifying that the desired boat loading trajectory is being followed, and a second color signifying that corrective action is required in order to follow the desired boat loading trajectory.

16. A method of guiding a boat onto a trailer, the method comprising:
providing at least one IR transmitter for transmitting IR signals;
providing at least one IR receiver for receiving IR signals transmitted by the at least one IR transmitter;
locating the at least one IR transmitter on one of:
adjacent a front of a trailer and along a longitudinal axis of the trailer for transmitting IR signals toward a rear of the trailer and along the longitudinal axis of the trailer; or
on a boat and along a longitudinal axis of the boat for transmitting IR signals toward a front of the boat and along the longitudinal axis of the boat;
locating the at least one IR receiver being on the other of:
on the boat for receiving the transmitted IR signals from the IR transmitter; or
adjacent the front of the trailer and along the longitudinal axis of the trailer for receiving the transmitted IR signals from the IR transmitter; and
having a processing unit communicating, with the at least one IR receiver, for determining when the IR signals, transmitted by the at least one IR transmitter, are received by the at least one IR receiver, and, when this occurs, indicating to the user, via the processing unit, that the longitudinal axis of the boat is aligned with the longitudinal axis of the trailer.

17. The method according to claim 16 further comprising utilizing a single IR transmitter, as the at least one IR transmitter, for transmitting the IR signals, and locating the single IR transmitter adjacent the front of the trailer and along the longitudinal axis of the trailer for transmitting the IR signals toward the rear of the trailer and along the longitudinal axis of the trailer; and
utilizing a single IR receiver, as the at least one IR receiver, for receiving the transmitted IR signals, and locating the single IR receiver on the boat and along the longitudinal axis of the boat for receiving the transmitted IR signals.

18. The method according to claim 16, further comprising utilizing a single IR transmitter, as the at least one IR transmitter, for transmitting the IR signals, and locating the single IR transmitter on the boat and along the longitudinal axis of the boat for transmitting the IR signals toward the trailer, and
utilizing a single IR receiver, as the at least one IR receiver, for receiving the transmitted IR signals, and locating the single IR receiver adjacent the front of the trailer and along the longitudinal axis of the trailer for receiving the IR signals transmitted toward the trailer.

19. The method according to claim 16, further comprising utilizing a single IR transmitter, as the at least one IR transmitter, for transmitting the IR signals, and locating the single IR transmitter adjacent the front of the trailer and along the longitudinal axis of the trailer for transmitting the IR signals toward the rear of the trailer and along the longitudinal axis of the trailer; and
utilizing first and second IR receivers, as the at least one IR receiver, for receiving the transmitted IR signals, and locating the first IR transmitter on the boat, on a first side of the longitudinal axis of the boat, for receiving the transmitted IR signals and locating the second IR transmitter on the boat, on an opposite second side of the longitudinal axis of the boat, for receiving the transmitted IR signals.

20. The method according to claim 16, further comprising utilizing a single IR transmitter, as the at least one IR transmitter, for transmitting the IR signals, and locating the single IR transmitter adjacent the front of the trailer and along the longitudinal axis of the trailer for transmitting the IR signals toward the rear of the trailer and along the longitudinal axis of the trailer; and
utilizing bow and stern IR receivers, as the at least one IR receiver, for receiving the transmitted IR signals, and locating the bow IR receiver adjacent a bow portion of the boat and along the longitudinal axis of the boat for receiving the transmitted IR signals, and locating the stern IR receiver adjacent a stern portion of the boat and along the longitudinal axis of the boat for receiving the transmitted IR signals.
